(19) United States
(12) Patent Application Publication
(10) Pub. No.: US 2026/0054399 A1
(43) Pub. Date: Feb. 26, 2026

(54) ELECTRIC HAIR TRIMMER FOR CUTTING INTIMATE HAIR

(71) Applicant: Braun GmbH, Kronberg (DE)

(72) Inventors: Gerd LASCHINSKI, Bad Homburg (DE); Markus SCHUESSLER, Koenigstein (DE); Cornelia Beate MARTYNUS, Nidderau (DE); Florian COP, Frankfurt (DE); Detlef GLEICH, Friedrichsdorf (DE)

(21) Appl. No.: 19/305,872

(22) Filed: Aug. 21, 2025

(30) Foreign Application Priority Data
Aug. 21, 2024 (EP) 24195690.3

(51) Int. Cl. B26B 19/04; B26B 19/06; B26B 19/38

(52) U.S. Cl. CPC B26B 19/042; B26B 19/06; B26B 19/3846; B26B 19/386

(57) ABSTRACT

The present invention relates to a cutter head for an intimate trimmer, comprising a pair of cooperating cutter blades each having at least one row of comb-like cutting teeth for long hair cutting, said cutter blades including a lower cutter blade and an upper cutter blade which is closer to a skin contact surface than said lower cutter blade and is movable in a cutting direction along a cutting surface defined between said cooperating cutter blades. The cutting teeth of the upper, movable cutter blade have tooth tips with obtuse tooth tip angles of more than 100° or more than 110° defined between a lower tooth side facing said cutting surface and a lower front side portion extending from said lower tooth side to a forward end point defining a maximum longitudinal tooth extension.

### FIELD OF THE INVENTION

The present invention relates to cutting body hair such as intimate hair cutting or body hair grooming in sensitive skin areas. More particularly, the present invention relates to a cutter head for an intimate trimmer or body groomer, comprising a pair of cooperating cutter blades each having at least one row of comb-like cutting teeth for long hair cutting, said cutter blades including a lower cutter blade and an upper cutter blade movable in a cutting direction relative to said lower cutter blade along a cutting surface defined between said cooperating cutter blades. The invention also relates to a hair cutter such as an intimate trimmer or body groomer, comprising an elongated handle and such cutter head attached to an end portion of said elongated handle.

### BACKGROUND OF THE INVENTION

Electric shavers and trimmers utilize various mechanisms to provide hair cutting functionality. Some electric shavers include a perforated shear foil cooperating with an undercutter movable relative thereto so as to cut hairs entering the perforations in the shear foil. Such shear foil type shavers are often used on a daily basis to provide for a clean shave wherein short beard stubbles are cut immediately at the skin surface.

On the other hand, other cutter systems including a pair of cooperating comb-like cutting elements with a plurality of comb-like or rake-like cutting teeth reciprocating or rotating relative to each other, are often used for cutting longer beard stubbles or curled body hair in intimate body regions or more generally, body hair being too long for shaving with a shear foil system. The teeth of such comb-like or rake-like cutting elements usually project substantially parallel to each other or substantially radially, depending on the type of driving motion, and may cut hairs entering into the gaps between the cutting teeth, wherein cutting or shearing is achieved in a scissor-like way when the cutting teeth of the cooperating elements close the gap between the finger-like cutting teeth and pass over each other.

Such cutter systems for longer hairs may be integrated into electric groomers or trimmers which at the same time may be provided with the aforementioned shear foil cutters. For example, there are electric trimmers or styling apparatus which are provided with a pair of such comb-like cutting elements spaced apart from each other and facing away from each other with a shear foil system arranged between said pair of rake-like cutting elements, cf. EP 41 19 313 A1. In the alternative, only one row of such comb-like cutting elements may be provided and accompanied by a shear foil system arranged on a trailing side thereof.

In such combined trimmers or groomers, the different cutter systems may provide for a two-step hair cutting action in one stroke, wherein the rake-like cutting elements, in a first cutting step, cut longer hairs and in a second step, the shear foil system cuts the stubbles remaining after the first step. Such two-step cutting can be achieved in a single move as the shear foil system is positioned on a rear side or trailing side of the long hair cutter so, when moving the cutter head over the skin in a direction substantially perpendicular to the extension of the row of rake-like cutting teeth, the shear foil system follows the comb-like cutting elements and shaves the skin areas which just have been passed by the comb-like cutting teeth. Thus, the rake-like cutting teeth form a pre-cutter unit and the shear foil system forms a final or subsequent cutter unit or post-cutter unit.

So as to achieve efficient cutting by the shear foil system, the hair stubbles left by the rake-like cutter elements, need to be short enough to find their way into the perforations of the shear foil cutter, wherein preferably such length of the remaining hair stubbles should be less than 1 mm. However, so as to cut long hairs such short, the user needs to move the cutter head, with the rake-like cutting elements, over the skin very closely thereto what poses the risk that the sharp, rake-like cutter elements interfere with the skin and generate irritations, small cuts and similar micro-injuries. Such risk is increased when using the hair cutter in sensitive skin regions such as a human's intimate regions where the skin is very soft and tends to easily bulge and thus, getting caught by the sharp tips of the rake-like cutting elements. Such problem of skin wrapping around the tooth tips of the rake-like cutting elements may cause skin irritations and skin injuries even when the upper one of the cooperating cutter blades is kept stationary, wherein such problem is aggravated by cutter systems having driven, e.g. reciprocating upper cutter blades.

So as to keep the cutting elements away from the skin at a certain distance therefrom, a distance comb may be attached to the cutter head, wherein such distance comb may include a plurality of ribs that may extend substantially parallel to a preferred or natural direction of movement of the cutter head over the skin. For example, for the aforementioned rake-like cutting elements for cutting longer hairs in a scissor-like way, the ribs of the distance comb may be oriented perpendicular to the row of teeth of such rake-like cutting elements. Such distance combs may be used to control the length of the hair remaining on the skin after cutting, wherein, e.g., a distance comb with ribs defining a skin contact surface 3 mm away from the rake-like cutting elements may be used for achieving a haircut leaving hairs of 3 mm length on the skin. On the other hand, such distance combs are also used for protecting sensitive skin against irritations such as nicks, cuts or abrasion when the hair cutter is used by less experienced users. For example, such distance comb is a helpful protector when using the hair cutter to cut hair in intimate regions of a body having very soft and sensitive skin that tends to easily get into the cutting elements.

However, such cutter heads are sometimes used without any protective combs so as to increase cutting efficiency and allow cutting the hairs very short or for trimming hair contours very exact. Using the cutter head without protective comb increases the risk of skin irritations and injuries such as skin cuts of course. So as to reduce such risk, the cooperating cutter blades often include a stationary blade and a movable or reciprocating blade, wherein the upper cutter blade closer to the skin contact surface is chosen as stationary blade, cf. EP 29 39 802 B1 and EP 31 31 711 B1.

EP 29 39 802 B1 further discloses of the cutting teeth of the upper, movable cutter blade have tooth tips having obtuse tooth tip angles of 160° defined between a lower tooth side facing said cutting surface and a lower front side portion extending from said lower tooth side to a forward end point defining a maximum longitudinal tooth extension. It was found that such large obtuse tooth tip angles significantly reduce the ability to cut hair or reduce the hair cutting efficiency as the hair is pushed aside before potentially being cut.

The arrangement of EP 31 31 711 B1 is disadvantageous in that particularly thin skin as provided in the human intimate area can still be cut by the cutting elements. Further, hair cutting efficiency is low as much hairs are pushed aside by the design of the protective comb.

With such setup, the stationary cutter blade which forms part of the skin contact surface when using the cutter head without protective comb, may protect the skin from contacting the reciprocating or moving lower cutter blade so the tendency of the skin getting wrapped around the moving teeth and thus getting into the cutting zone, is reduced to some extent.

It nevertheless may be desired for some reason to have the upper cutter blade closer to the skin contact surface to reciprocate or move. Such upper cutter blade is arranged on the side of the lower cutter blade that is opposite to a handle connecting portion of the cutter head and/or facing away from such handle connecting portion and thus, on the lower cutter blade's side facing away from the handle. In other words, the upper cutter blade is on top of the lower cutter blade and thus, closer to the skin contact surface than the lower cutter blade. For example, when the upper cutter blade is moving, difficult hair such as curled hair or hair lying flat on the skin is sort of activated or fluffed up so cutting performance may be increased. Furthermore, when the upper cutter blade closer to the skin is moving, the lower cutter blade, with its teeth projecting beyond the upper teeth, may enter the gaps between neighboring hairs more easily and, when considering the usual direction of movement of the cutter head, without transverse movements and thus, without deflecting the hairs too much what helps in getting the hairs into the cutter gaps between neighboring teeth.

So as to achieve at least some skin protection when the upper cutter blade closer to the skin is moving, it has been suggested to provide the tooth tips of the teeth of the lower stationary cutter blade with thickened ends projecting towards the skin to push the skin away from the movable teeth of the upper cutter blade, cf. EP 1 963 057 B1. However, pushing away the skin from the movable teeth of the upper cutter blade is detrimental to cutting efficiency and prevents the cutter head from cutting the hairs very short.

### SUMMARY OF THE INVENTION

It is an objective underlying the present invention to provide for an improved hair cutter allowing for improved intimate hair cutting or body hair grooming in sensitive skin areas. More particularly, it is desired to achieve efficient body hair grooming or intimate hair cutting without sacrificing skin protection and safety against skin irritations or skin injuries.

Another objective of the present invention is to provide for reliable skin protection for a blade set comprising a movable upper cutter blade closer to the skin to allow efficient short hair cutting without skin irritations when using the cutter head without protective comb.

To achieve at least one of the aforementioned objectives, it is suggested to shape the tooth tips of the moving teeth of the upper movable blade to have an overhanging contour when viewing the tooth tips from the skin side or from an upper tooth side facing the skin. More particularly, the cutting teeth of the upper movable cutter blade may have tooth tips with obtuse tooth tip angles of more than 100° or more than 110° and less than 150° or less than 140° defined between a lower tooth side facing the cutting surface between the cooperating cutter blades and a lower front side extending from said lower tooth side to a forward end point of the tooth tip defining a maximum longitudinal tooth extension.

Due to such beveled, recessed lower front side of the tooth tips of the movable upper teeth, the tendency of the skin to get caught in the cutting zone at the tooth tips of the movable teeth is reduced even when the skin is bulging and wrapping, to some extent, around the tooth tips of the movable teeth as the skin may not follow the overhanging contour and thus, is prevented from reaching the contact point where the tooth tips of the upper movable teeth contact the lower teeth.

Depending on rounding of the tooth tips, such forward end point of the tooth tip does not need to be a single point in a strictly mathematical sense but may be representative of a line on the contour of the tooth tip defining the maximum longitudinal tooth extension. For example, when the tooth tip is spherically or multi-axially rounded, the forward end point indeed may be a single point, whereas in case of rounding only in planes perpendicular to the cutting surface, the tooth tip may have a blunt front side when viewed from the top and thus, a straightforward end line which may be parallel the cutting direction. Nevertheless, the forward end point is representative of such straight forward end line as it is one point on this line defining the maximum longitudinal tooth extension. The forward end point may be seen when viewing the tooth tip in a direction parallel to the cutting direction.

Said obtuse tooth tip angle may range from 100° to 150° or from 100° to 140° or from 110° to 140° or from 110° to 130° or more particularly, from 115° to 125° to combine reliable skin protection with still high efficiency in cutting hair short.

Due to said beveling of the lower front side surface of the tooth tips, the maximum length of the moving upper teeth is not defined on the cutting surface, but above the cutting surface. When considering the aforementioned forward end point of the tooth tips defining the maximum longitudinal tooth extension of the cutting teeth of the upper movable cutter blade, such forward end points may be spaced from the cutting surface between the cooperating cutter blades and thus, from an upper surface of the lower cutter blade, by a distance which may correspond to about 10% to 90% or 20% to 80% or 25% to 75% of a thickness of said cutting teeth of the upper movable cutter blade which may be measured between lower and upper tooth sides in a region where the lower tooth side contacts the cutting teeth of the lower cutter blade.

An upper front side of the tooth tips extending from said forward end points to an upper tooth side of the cutting teeth of the upper movable cutter blade may be rounded to further prevent skin irritations, wherein said upper front side may define together with the aforementioned lower front side, at said forward end points, an obtuse angle of more than 100° or more than 110° or ranging from 110° to 140° or from 125° to 135°. When considering the rounded contour of the upper front side, such obtuse angle may define the inclination or tangential direction in which the upper front side starts extending from the forward end point.

These and other advantages become more apparent from the following description giving reference to the drawings and possible examples.

### BRIEF DESCRIPTION OF THE DRAWINGS

FIG. 1: a perspective view of an intimate hair trimmer comprising a cutter head attached to an end portion of an elongated handle,

FIG. 2: a perspective view of the cutter head of the hair trimmer of FIG. 1 sharing the cutter head frame and its connecting portion to be connected to the handle,

FIG. 3: a plane top view onto the cutter head of FIG. 2 showing the shear foil system in a center portion and the comb-like cutting teeth on opposite sides of the shear foil system,

FIG. 4: a perspective view of the cutter head of FIGS. 2 and 3 showing the arrangement of the comb-like cutting teeth and the shear foil system,

FIG. 5: a partial, enlarged top view of the comb-like teeth of the cooperating cutter blades for long hair trimming showing the geometry of the teeth and the cutter slots between the teeth,

FIG. 6: a top view of the overlapping teeth of the upper and lower cutter blades,

FIG. 7: a cross-sectional view of a pair of cooperating teeth of the upper and lower cutter blades taken along line G-G in FIG. 6, said cross-sectional view showing the overhanging tooth tip contour of the cutting teeth of the upper cutter blade,

FIG. 8: a cross-sectional view of a pair of cooperating cutting teeth of the upper and lower cutter blades similar to FIG. 7, but taken in the region of cutter slots between the teeth,

FIG. 9: a cross-sectional view of cooperating cutting teeth similar to FIG. 7,

FIG. 10: an enlarged cross-sectional view of a cutting tooth of the lower cutter blade, wherein the cross-section is taken in a plane going through a cutter slot to show a side surface of the cutting tooth,

FIG. 11: a perspective view of the upper movable cutter blade including two rows of cutting teeth,

FIG. 12: a perspective partial view of a cutting tooth of the cutter blade of FIG. 11 to show the rounded, overhanging tooth tip contour,

FIG. 13: a cross-sectional view of a cutting tooth of the upper movable cutter blade to show the obtuse angle defined between a lower front-side portion and an upper front-side portion of the tooth tip,

FIG. 14: a perspective view of an intimate hair trimmer with a protective attachment attached to the cutter head of the trimmer,

FIG. 15: a perspective view of the cutter head and the attached protective attachment removed from the handle of the hair trimmer,

FIG. 16: a perspective view of the cutter head without protective attachment, to show the cutter head's cutter system including two rows of rake-like cutting teeth and a shear foil cutter system positioned between said two rows of cutting teeth,

FIG. 17: a perspective view of the protective attachment showing two rows of protective teeth on opposite sides of an attachment frame,

FIG. 18: a perspective view of the cutter head in a view similar to FIG. 3, but the protective attachment of FIG. 4 being attached to the cutter head,

FIG. 19: a front view of the cutter head with the protective attachment attached thereto,

FIG. 20: a cross-sectional view of the cutter head and the protective attachment along the line A-A in FIG. 6,

FIG. 21: an enlarged cross-sectional view of the cutter head and more particularly, the part of the cutter head marked by the hatched circle B in FIG. 7,

FIG. 22: an enlarged, partial cross-sectional view of the cutter head and the mounted protective attachment in a view similar to FIG. 8, wherein two virtual tangential planes are shown to illustrate the positioning of the rake-like cutting teeth and the contour of the skin contact surface of the cutter head,

FIG. 23: a side view of a protective tooth of the protective attachment in a partial view to illustrate the rounded contour of the protective tooth at an edge facing away from the rake-like cutting teeth,

FIG. 24: a plane top view of the cutter head illustrating the positioning of the rows of protective teeth in front of the rows of cutting teeth and the entirely free axes to the shear foil system, and

FIG. 25: a side view of a protective tooth of the protective attachment in partial view to illustrate inclined skin contacting surface on the top side of the tooth.

### DETAILED DESCRIPTION OF THE INVENTION

So as to achieve reliable skin protection for a blade set comprising a movable upper cutter blade closer to the skin than a lower cutter blade, the tooth tips of the moving teeth of the upper movable blade have an overhanging contour when viewing the tooth tips from the skin side or from an upper tooth side facing the skin. More particularly, the cutting teeth of the upper movable cutter blade may have tooth tips with obtuse tooth tip angles of more than 100° or more than 110° defined between a lower tooth side facing the cutting surface between the cooperating cutter blades and a lower front side extending from said lower tooth side to a forward end point of the tooth tip defining a maximum longitudinal tooth extension.

Such beveled, recessed lower front side of the tooth tips of the movable upper teeth help to reduce the tendency of the skin to get caught in the cutting zone at the tooth tips of the movable teeth, even when the skin is bulging and wrapping, to some extent, around the tooth tips of the movable teeth as the skin may not follow the overhanging contour and thus, is prevented from reaching the contact point where the tooth tips of the upper movable teeth contact the lower teeth.

Said obtuse tooth tip angle may range from 100° to 140° or from 110° to 130° or more particularly, from 115° to 125° to combine reliable skin protection with still high efficiency in cutting hairs short.

Due to said beveling of the lower front side surface of the tooth tips, the maximum length of the moving upper teeth is not defined directly on the cutting surface, but on a level above the cutting surface. More particularly, the aforementioned forward end point of the tooth tips of the cutting teeth of the upper movable cutter blade may be spaced from the cutting surface between the cooperating cutter blades and thus, from an upper surface of the lower cutter blade, by a distance which may correspond to about 10% to 90% or 20% to 80% or 25% to 75% of a thickness of said cutting teeth which may be measured between lower and upper tooth sides in a region where the lower tooth side contacts the cutting teeth of the lower cutter blade.

An upper front side of the tooth tips extending from said forward end points to an upper tooth side of the cutting teeth of the upper movable cutter blade may be rounded to further prevent skin irritations, wherein said upper front side may define, together with the aforementioned lower front side, at said forward end point in a longitudinal middle plane of the tooth perpendicular to the cutting direction, an obtuse angle of more than 100° or more than 110° or ranging from 110° to 140° or from 125° to 135°. When considering the rounded contour of the upper front side, such obtuse angle may define the inclination or tangential direction in which the upper front side starts extending from the forward end point.

Due to the overhanging contour of the tooth tips of the upper movable cutting teeth, a step-like recess is formed in front of the tooth tips of the upper movable cutting teeth between said tooth tips and the upper side of the lower cutting teeth of the lower cutter blade, wherein such step-like recess may define an acute angle of less than 80° or less than 70° which may be measured between an upper tooth side of a projecting portion of the cutting teeth of the lower cutter blade projecting beyond the cutting teeth of the upper cutter blade, and the aforementioned lower front side portion of the tooth tips of the cutting teeth of the upper cutter blade.

More particularly, said acute angle at the recess in front of the tooth tips of the upper cutting teeth and the upper tooth sides of the lower teeth may range from 50° to 70° or from 55° to 65°. Due to such acute angle at said recess, the cutting zone at the tooth tips of the movable cutting teeth is sufficiently recessed from the forward end points of said cutting teeth to achieve reliable skin protection, whereas on the other hand the length of the cutting teeth of the upper movable cutter blade is still utilized to a large extent and thus, cutting efficiency is still high.

The aforementioned lower front side portion of the cutting teeth of the upper cutter blade may be substantially plane.

The cutting teeth of the lower cutter blade may project, in longitudinal tooth direction, beyond the tooth tips of the cutting teeth of the upper, movable cutter blade by a projecting distance which may range from about 50% to 150% or from 75% to 130% of the overlapping length of the teeth.

Such overlapping length defines the overlap along which, in said longitudinal tooth direction, the cutting teeth of the upper cutter blade are indeed contacting the cutting teeth of the lower cutter blade. In other words, such overlapping length defines the length of the cutting zone in which cutting action is achieved due to sliding the teeth over one another in a scissor-like manner.

Due to such rather long projecting distance of the lower teeth beyond the upper teeth, the cutting teeth of the lower cutter blade which may be stationary, may thread into the gaps between hairs to be cut, when considering the usual feed motion of the cutter head along the skin, i.e. when the cutter head is stroked along the skin with the row of comb-like teeth going ahead, so as to sort of properly arrange the hairs before entering into the cutting zone. For example, the projecting portions of the lower teeth may erect or straighten up hairs lying flat on the skin before such hairs enter into the gap or cutting slot between neighboring teeth where the cutting zone is defined.

Furthermore, such projecting portions of the lower teeth may also form part of the skin contact surface when using the cutter head without protective comb, wherein such part of the skin contact surface defined by the lower teeth may help in straightening the skin or preventing skin from too much bulging before getting into contact with the movable teeth of the movable upper cutter blade.

In particular, the cutting teeth of the lower cutter blade may have at their tooth tip portions, a tooth width in the cutting direction and thus, transverse to the aforementioned feed motion of the cutter head, that ranges from about 0.5 mm to about 1 mm or from about 0.5 mm to about 0.75 mm or from about 0.6 mm to about 0.7 mm. Such tooth width at their tooth tip portions allows the cutting teeth of the lower cutter blade to easily enter between hairs which are usually spaced apart from each other at a distance allowing the cutting teeth having such tooth tip width to be threaded between neighboring hairs.

Irrespective of such tooth width, the cutting teeth of the lower cutter blades may define cutter slots between each other having a slot width which, when measured in the region of the tooth tips of the cutting teeth of the upper cutter blade, may range from about 0.2 mm to about 0.4 mm or from about 0.25 mm to about 0.36 mm or from about 0.30 mm to about 0.36 mm. Such cutter slot width of the cutting teeth of the lower cutter blade ensures high cutting efficiency on the one hand and reliably prevents skin, even when bulging, from entering into the cutter slots deep enough to reach the cutting zone on the other hand.

The upper cutter blade may have a tooth width of the cutting teeth in said cutting direction different from the tooth width of the cutting teeth of the lower cutter blade. More particularly, the tooth width of the cutting teeth of the upper movable cutter blade, when measured in a middle portion of the cutting surface in which the cutting teeth of the upper and lower cutter blades contact each other, may range from about 33% to about 66% or from about 40% to about 60% of the tooth width of the cutting teeth of the lower cutter blade.

Irrespective of the tooth width, the cutting teeth of the upper movable cutter blade may define cutter slots between each other ranging from about 120% to 150% or from 125% to 135% of said tooth width of the cutting teeth of the upper cutter blade.

When comparing the upper cutter blade to the lower cutter blade, the cutting teeth may be arranged at different tooth pitches. More particularly, the cutting teeth of the upper cutter blade may be spaced apart from each other by a tooth pitch which is smaller than the tooth pitch of the cutting teeth of the lower cutter blade. For example, the tooth pitch of the upper movable cutter blade may range from about 75% to 95% or from about 80% to about 90% of the tooth pitch of the cutting teeth of the lower cutter blade. In other words, the cutting teeth of the upper cutter blade may be positioned closer to each other than the cutting teeth of the lower cutter blade, or the density of teeth, i.e. the number of teeth per length unit may be higher at the upper movable cutter blade than at the lower cutter blade.

Considering the aforementioned ranges of tooth width and cutter slot width of the upper and lower cutter blades, it basically still would be possible for intensively bulging skin to get into the cutter slots when the cutter blades were not moving relative to each other. However, the skin need some time to change their contouring and more particularly, skin may not bulge instantly. This is in particular relevant as it is the upper cutter blade which is moving since the movable upper cutter blade is constantly pushing the skin away due to its cutting movements.

So as to reliably prevent the skin from entering into the cutter slots and from getting cut in the cutting zone, the upper movable cutter blade may be driven or may be reciprocated at a frequency of more than 75 Hz or more than 90 Hz. For example, a reciprocating frequency may range from 80 to 170 Hz or from 80 to 130 Hz to allow, on the one hand, hairs properly enter into the cutter slots and prevent the movable teeth from boxing away hairs trying to enter, and, on the other hand, sufficiently push away skin from entering into the cutter slots.

To strengthen such functionality, the cutting teeth of the upper movable cutter blade may have a pair of side surfaces opposite to each other and extending transverse to the cutting direction, which side surfaces may be inclined to the lower tooth side facing the cutting surface at an acute angle of less than 85° or less than 80° or ranging from 70° to 80°. In other words, the cutting teeth of the upper cutter blade may be tapered towards their upper tooth side, wherein the aforementioned acute angles of the side surfaces to the lower tooth side make the cutting edges sufficiently sharp to achieve efficient hair cutting and on the other hand, make the side surfaces sufficiently steep to prevent bulging skin from getting into the cutting zone, in particular when reciprocating the upper blade at a sufficient frequency.

So as to further increase skin protection for unexperienced users, the trimmer may be used, despite the skin protecting tooth geometry as described above, together with a protective comb attached to the cutter head. More particularly, the cutter head may be provided with a protective attachment partly forming the skin contact surface of the cutter head such that the rake-like cutting teeth are slightly recessed from the skin contact surface formed by the protective attachment.

Advantageously, the protective attachment may include a row of comb-like protective teeth arranged along a front side of said cutting teeth opposite to the shear foil system on the rear or trailing side thereof, wherein said comb-like cutting teeth may be arranged in a countersunk position below a virtual tangential plane to the shear foil system and the comb-like protective teeth of the protective attachment. Thus, the skin over which the cutter head stroked is guided in a bridge-like manner to sort of flow or glide over the tooth tips of the cutting teeth, wherein the protective teeth of the protective attachment on the front side of the cutting teeth and the shear foil system on the rear side of the cutting teeth form a sort of bridge abutment. Due to the countersunk position of the cutting teeth on a rear side of the protective teeth, the skin is reliably prevented from wrapping around the tooth tips even when bulging towards the cutter head between said protective teeth and the shear foil system. Such virtual tangential plane may be, but does not have to be exactly tangential onto the shear foil system and the protective teeth in a strictly mathematical sense, i.e. having a contact line or contact point on each of said shear foil system and row of protective teeth, but such tangential plane may, for example, contact or lie onto the row of protective teeth and be spaced a minor distance from the shear foil to almost touch said shear foil, or may be slightly inclined by a minor angle vis-à-vis a plane that is tangential in the strict mathematical sense.

Advantageously, said row of protective teeth and the shear foil system may together form parts of the skin contact surface of the cutter head, wherein said skin contact surface may have a depression or a deepening for skin bulging between said row of protective teeth and said shear foil system, wherein said row of cutting teeth for long hair cutting is arranged in said depression. Such arrangement of the cutting teeth in a depression of the skin contact surface of the cutter head allows the skin to bulge towards the cutter head and thus, ensures solid skin contact to the shear foil system and still prevent the skin from wrapping around the tooth tips.

When considering a stroke of the cutter head over a skin portion, which stroke may have a direction substantially perpendicular to the longitudinal extension of the row of cutting teeth with the cutting teeth going ahead, the skin is allowed to bulge towards the cutter head to some extent behind the comb-like cutting teeth, i.e. after having passed the protective teeth and the cutting teeth, so the skin may solidly contact the following shear foil system and thus, the left stubbles may reliably enter into the perforations of the shear foil system, whereas the countersunk positioning of the cutting teeth prevents the skin from wrapping around the tooth tips.

The offset of the cutting teeth from the aforementioned virtual tangential plane into said countersunk position may be rather small and may be adapted to the size of the perforations of the shear foil system. More particularly, said offset into the countersunk position may substantially correspond to or may be slightly smaller than the diameter of the perforations so as to, on the one hand, make the left hair stubbles reliably find their way into the perforations of the shear foil system and, on the other hand, keep the skin away from the tooth tips of the rake-like cutter element by a sufficient distance to avoid skin irritations and skin injuries.

For example, the offset of the rake-like cutter elements from said virtual tangential plane may range from 25% to 125% or from 33% to 100% or from 50% to 95% or from 66% to 95% or from 75% to 95% of the diameter of the perforations of said shear foil system.

For example, such offset distance may range from, e.g., 0.1 to 0.6 mm or from 0.3 to 0.5 mm.

The perforations of the shear foil of the shear foil system may have a diameter or maximum width of about 0.4 to 0.6 mm or about 0.5 mm.

So as to allow hairs to reliably enter the channel-like recesses between the cutting teeth despite the protective teeth of the protective attachment being positioned, when considering the direction of a stroke of the cutter head over the skin, in front of the cutting teeth, the number of protective teeth of the protective attachment may be smaller than the number of the cutting teeth to provide for additional space between the protective teeth and to make it easy for the hairs to pass the protective teeth.

More particularly, the number of protective teeth may range from only 20% to 80% or 25% to 50% of the number of cutting teeth. Due to such reduced number of protective teeth, there are less obstacles in front of the row of cutting teeth to be passed by the hair to be cut. In other words, the protective attachment, despite its protective teeth positioned in front of the cutting teeth, does not block the cutting teeth and more particularly, does not prevent hair from entering into the gaps between the cutting teeth. Nevertheless, such reduced number of protective teeth may suffice to prevent the skin from wrapping around the tooth tips.

So as to further reduce such blocking effect and to keep the entering channels free from obstacles, the arrangement of the protective teeth of the protective attachment may have a toothing pitch that is an integer multiple of the toothing pitch of the cutting teeth.

More particularly, the protective teeth may be arranged such that a protective tooth is arranged in front of every second or every third or every fourth stationary cutting tooth of the rake-like cutting teeth of the cooperating cutter blades. Such alignment of the protective teeth with the stationary teeth of the stationary cutter blade maximizes the width of the channels for the hairs entering into the gaps between the cutting teeth and thus minimizes the likelihood of hairs flexing away from the cutting edges of the cutting teeth and thus, of hairs being blocked from entering into the cutting zones of the coopering cutter blades.

So as to allow the shear foil system efficiently cut the hair stubbles left by the cooperating cutter blades and thus, to allow clean hair cutting by only one stroke, the protective attachment may be formed exclusively outside a central cutter head region in which at least said shear foil system is positioned so as to allow the skin solid contact to the shear foil system. In particular, the protective attachment does not include any protective ribs extending over the shear foil system.

More generally, when considering a viewing direction perpendicular onto the aforementioned virtual tangential plane onto the shear foil system and the protective teeth of the protective attachment, at least the shear foil system is left entirely unobstructed by the protective attachment.

More particularly, said central cutter head region left unobstructed by the protective attachment may be a bit larger than the outline of the shear foil cutter system. More particularly, the protective attachment may be formed exclusively outside a central cutter head region comprising the shear foil system plus the at least one row of cutting teeth or, when a pair of rows of cutting teeth are provided, said shear foil system plus said two rows of cutting teeth.

According to a further aspect, a skin contact bracket may be provided between the shear foil system and said at least one row of cutting teeth, wherein a deepening may be provided between said skin contact bracket and said shear foil system and/or a deepening may be provided between said skin contact bracket and said row of cutting teeth. Such skin contact bracket may have a rib-like, elongated contour and may extend along a rear side of the cutting teeth.

For example, on both sides of said skin contact bracket which may extend along an edge portion of the shear foil system, elongated, groove-like or chamfered depressions may be provided. Such skin contact bracket between the shear foil system and the neighboring or adjacent row of cutting teeth may form another sort of bridge abutment guiding the skin over the rake-like cutting teeth even when soft skin is bulging toward the cutter head. More particularly, the skin contact surface may form a sort of stopper to bulging skin and shortens the distance of free skin bulging between the protective teeth of the attachment on the one hand and the shear foil system's surface on the other hand.

Such skin contact surface may form a part of the skin contact surface of the cutter head, wherein such part of the skin contact surface formed by the skin contact bracket may be formed tangential to or adjacent to a virtual tangential plane onto the shear foil system on the one hand and said row of cutting teeth on the other hand. Thus, said skin contact bracket prevents the skin from bulging deeper than the upper surface of the cutting teeth. Since the protective teeth of the protective attachment on the other side of the cutting teeth is elevated with regard to the upper surface of the cutting teeth, the skin contact bracket having a surface tangential to a plane touching the upper surface of the cutting teeth on the one hand and the shear foil system on the other hand, effectively prevents the skin from touching the cutting teeth and on the other hand, allows for closeness of the cutting teeth to the skin to cut long hair sufficiently short.

Such tangential plane defining the contour and orientation of the skin contact bracket is different from the above-mentioned first virtual tangential plane used for defining the countersunk position of the cutting teeth. As mentioned before, the first virtual tangential plane is defined by contacting, on the one hand, the protective teeth of the protective attachment and, on the other hand, the shear foil system. In contrast, the second virtual tangential plane defining the contour or orientation of the skin contact bracket, is defined by contact too, on the one hand, the upper surface of the cutting teeth and, on the other hand, the shear foil system.

Said skin contact bracket may have a skin contact surface that is substantially planar and inclined such that it is substantially tangential to the aforementioned second virtual tangential plane.

On the other hand, the protective teeth of the protective attachment also may have a substantially planar top end surface which may be oriented substantially tangential to said aforementioned first virtual tangential plane defined by contact to the shear foil system and the row of protective teeth.

So as to allow smooth gliding or sliding over the skin, the protective teeth of the attachment may have an outer edge that is rounded. Such outer edge may be the protective teeth edge that is facing away from the row of cutting teeth. More particularly, when considering the direction of a stroke of the cutter head moving the protective teeth over the skin in front of the rake-like cutting teeth, said rounded edge may be the front edge of the protective teeth.

Said rounded front edge of the protective teeth of the protective attachment may connect tooth flanks which are inclined to each other at an acute angle which acute angle may range from about 60° to 90° or from 70° to 89° or from 75° to 85°. Such acute angle helps in combining a slim, compact size of the protective teeth with smooth sliding of the protective attachment over the skin. Such slim, compact size helps in making hairs reliably and directly enter into the gaps between the rake-like cutting teeth.

Both of said cooperating cutter blades having said rake-like cutting teeth may be movable to be driven by a drive unit, wherein it may be advantageous to have one stationary cutter blade and one driven cutter blade. For example, an upper cutter blade that is closer to the skin than a lower cutter blade may be stationary and the lower cutter blade may be driven in a, for example, reciprocating linear or rotatory way. On the other hand, according to an aspect, it may be the upper cutter blade that is driven, whereas the lower cutter blade further away from the skin may be stationary. Due to the highly efficient protection of the protective attachment, it is possible to have the upper cutter blade reciprocate without sacrificing skin protection.

So as to allow for safe use by unexperienced users as well as for maximum performance for skilled users, the protective attachment may be releasably attached to or snap fitted with said cutter head frame with the cutter head. Releasable attachment elements of the protective attachment also allow for easy cleaning.

As mentioned, the cutter head may have only one row of rake-like cutting teeth. On the other hand, so as to allow for stroking the cutter head over the skin in two opposite directions, the cutter head may be provided with two rows of rake-like cutting teeth which may be facing away from each other and spaced apart from each other with the shear foil system being positioned between said two rows of cutting teeth.

Irrespective of the number of rows of cutting teeth, the protective attachment may have a substantially ring-shaped configuration, wherein the protective attachment may include a ring-shaped attachment frame which may be provided with two rows of protective teeth along opposite frame legs. Even when using the attachment in combination with a cutter head only having one row of rake-like cutting teeth, it is useful to have a protective attachment having two rows of protective teeth to prevent beginners from attaching the protective attachment in a wrong orientation and to not need attachment keys allowing for attachment in only one orientation. At the same time, the same protective attachment may be used for cutter heads having only one row of cutting teeth and cutter heads having a pair of rows of cutting teeth.

When the cutter head has such two rows of cutting teeth facing away from each other and spaced apart from each other, the protective teeth along opposite frame legs of the ring-shaped attachment frame may be positioned along front sides of said two rows of cutting teeth. The attachment frame may be configured to extend around the shear foil system and around said two rows of cutting teeth, wherein the protective teeth are arranged front sides of said two rows of cutting teeth.

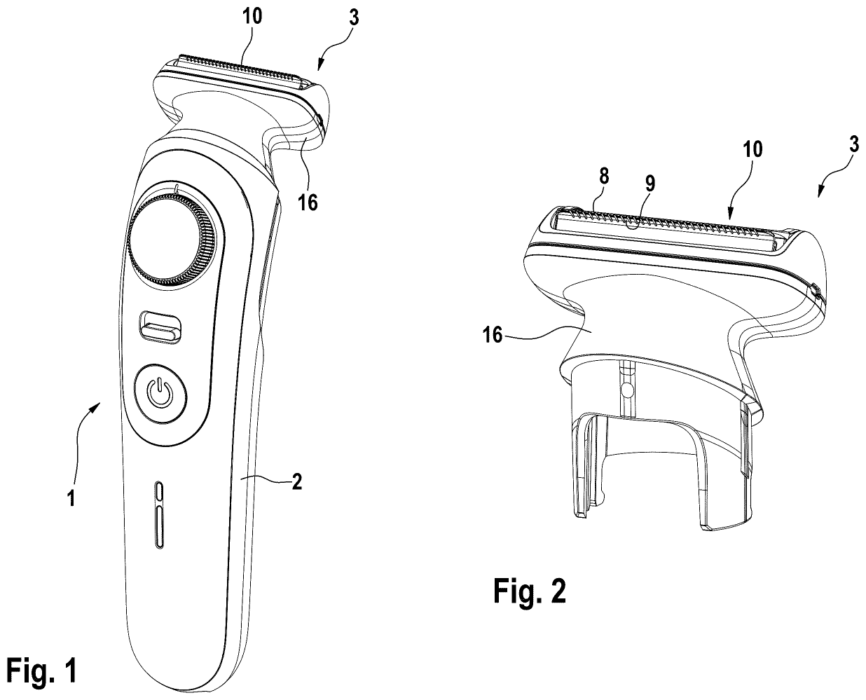

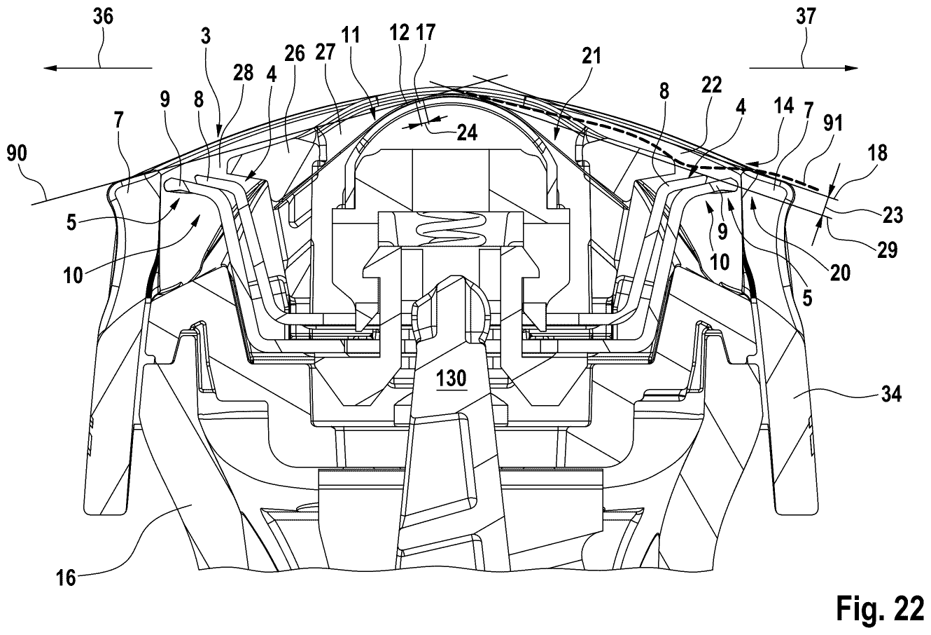

As can be seen from FIGS. 1 and 2, a cutter head 3 may be attached to a handle 2 of an electric body groomer or an intimate trimmer 1. More particularly, the groomer and/or trimmer 1 may include an elongated handle 2 accommodating the electronic and/or electric components such as a control unit, an electric or a magnetic drive motor and a drive train 130, cf. FIGS. 21 and 22, for transmitting the driving action of the motor to the cutter system 19 of the cutter head 3 which cutter head 3 may be positioned at one end of the elongated handle 2, cf. FIG. 1.

The cutter system 19 includes a pair of cooperating cutter blades 4 and 5 and furthermore, a shear foil system 11, wherein, for example, the cutter system 19 may have at least one row 10 of cooperating rake-like cutting teeth 8, 9 which may be positioned along an edge portion of a shear foil cutter 12.

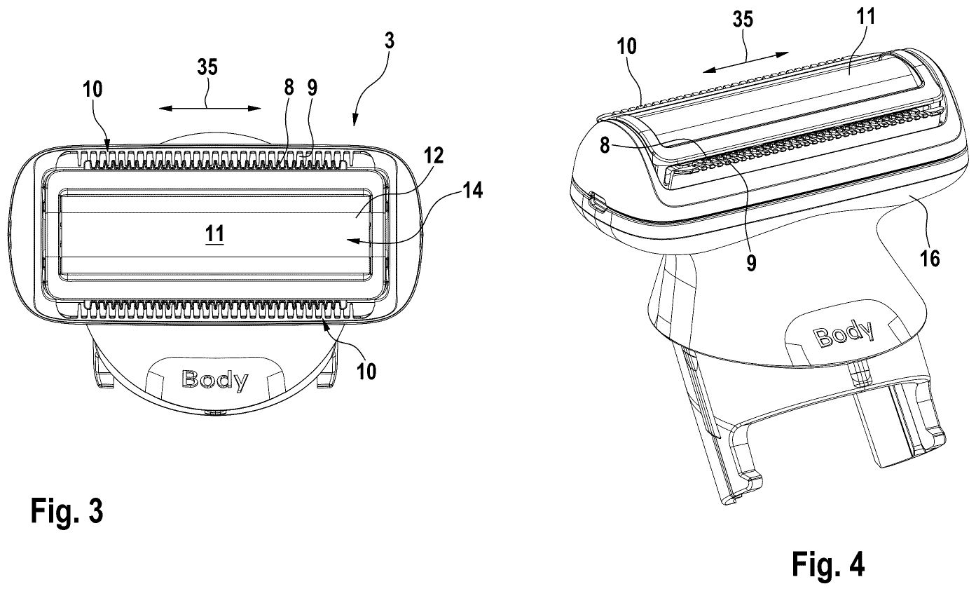

Said row 10 of cutting teeth may reciprocate relative to each other along a linear path defining the cutting direction 35, cf. FIGS. 3 and 4, so as to effect the cutting action by closing the gaps between the teeth and passing over each other. On the other hand, the cutter system also might include cutting teeth aligned along a circle and/or are arranged radially. Such rotatory cutting elements may have cutting teeth projecting substantially radially, wherein the cutting elements may be driven to rotate relative to each other and/or to rotatorily oscillate relative to each other. The cutting action is basically similar to reciprocating cutting elements as the radially extending teeth, when rotating and/or rotatorily oscillating, cyclically close and reopen the gap between neighboring teeth and pass over each other like a scissor.

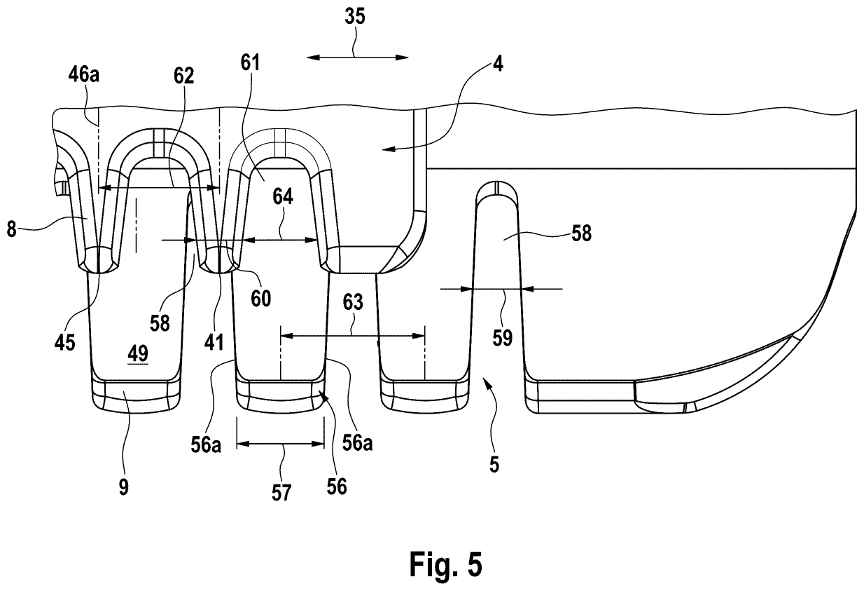

As illustrated by FIG. 5 and FIG. 22, it may be the upper one 4 of said pair of cutter blades 4, 5 which is driven, whereas the lower one 5 of said cooperating cutter blades 4, 5 may be stationary, i.e. non driven by the motor. A transmitter of the aforementioned drive train 130 may transmit the driving action to the upper cutter blade 4 to make the upper cutter blade 4 reciprocate, cf. FIG. 22.

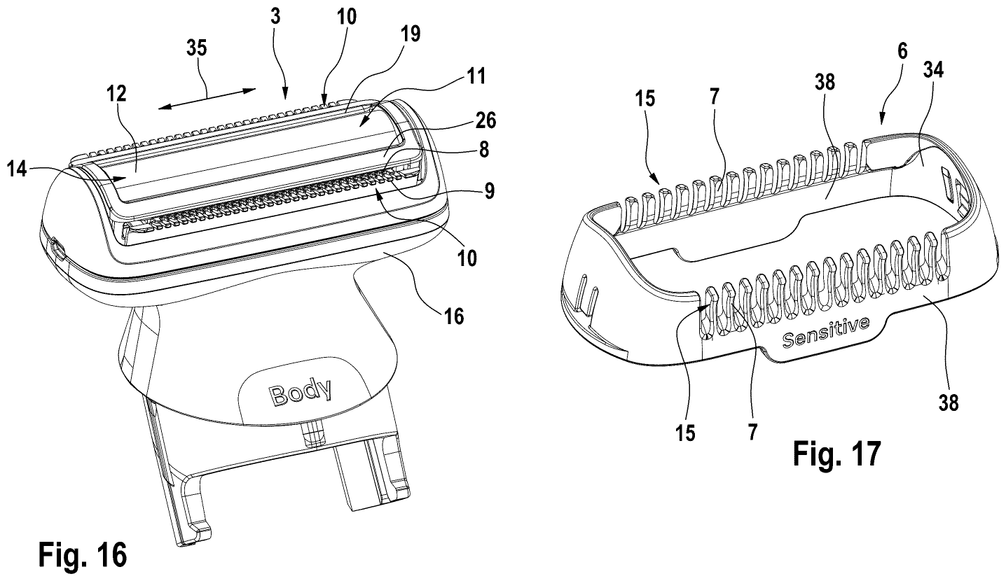

The shear foil system 11 may include a shear foil cutter 12 comprising a perforated shear foil forming an upper cutter element and a lower cutter comprising a plurality of blade-like cutting shoulders in contact with and sliding on a lower or inner surface of the shear foil, cf. FIG. 22 illustrating one of the perforation 17 in the shear foil having a perforation diameter 24. As illustrated by FIG. 22, the shear foil cutter 12 may have a curved upper surface forming a cylindrical or elongated convex surface, cf. FIG. 16.

Similar to the reciprocating of the cutter blades, 4, 5 relative to each other, also the shear foil cutter 12 may be driven in a reciprocating manner, wherein it may be the lower cutter that is driven by the transmitter of the drive train 130 to reciprocate a long linear path 35. Thus, the reciprocating movements of the cutter blade 4, 5 on the one hand and of the shear foil cutter 12 on the other hand may be parallel to each other and/or parallel to a longitudinal axis of the cutter head 3, cf. FIGS. 3 and 4.

As can be seen from FIGS. 3 and 22, the upper surface of the shear foil system 11 may form a part of the skin contact surface 14 of the cutter head 3.

Also, the outer or upper one 4 of said cutting elements 4, 5 may itself define a part of the skin contact surface 14 of the cutter head 3 at a forward end portion of the cutter head 3, when using the hair cutter 1 without protective attachment 6, cf. FIGS. 3 and 4 and 16.

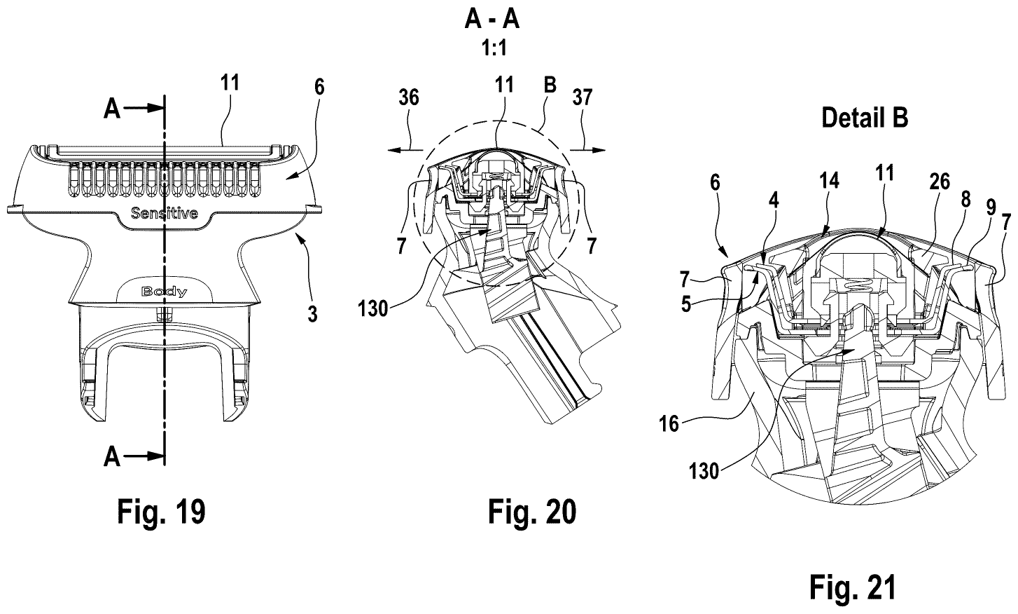

On the other hand, when the protective attachment 6 is attached to the cutter head 3, it is not the upper/outer cutting element 4 itself, but such protective attachment 6 which defines, together with the shear foil system 11 the skin contact surface 14 of the cutter system, cf. FIGS. 16 and 19. More particularly, the surface of the distance comb 6 facing away from the handle 2 or from the cutting elements 4, 5 may define the skin contact surface 14, cf. FIGS. 5, 8 and 9. Another part of the skin contact surface is still defined by the shear foil system 11 also when the protective attachment 6 is mounted.

As can be seen from FIGS. 3 and 4 the cutter system 19 may include two rows 10 of cutting teeth 8, 9 which rows 10 are spaced apart from each other, wherein the shear foil system 11 is positioned in-between said two rows 10 of cutting teeth 8, 9. The cutting teeth 8, 9 of said two rows 10 are facing away from each other to allow for stroking the cutter head 3 over the skin in opposite stroking directions 36, 37, cf. FIGS. 20 and 22 showing such stroking directions 36 and 37.

So as to achieve reliable skin protection, the tooth tips 41 of the moving teeth 8 of the upper movable blade 4 may have an overhanging contour when viewing the tooth tips 41 from the skin side or from an upper tooth side facing the skin. Such viewing direction is actually shown in FIGS. 3, 5 and 6, but the overhanging contour of the tooth tips 41 can be better seen in FIGS. 7 to 10 showing cross-sectional side-views having a viewing axis parallel to the cutting direction 35.

More particularly, the cutting teeth 8 of the upper movable cutter blade 4 may have tooth tips 41 with obtuse tooth tip angles α of more than 100° defined between a lower tooth side 42 facing the cutting surface 40 between the cooperating cutter blades 4, 5 and a lower front side portion 44 extending from said lower tooth side 42 to a forward end point 45 of the tooth tip 41 defining a maximum longitudinal tooth extension, cf. FIGS. 7, 8, 9 and 10.

Such beveled, recessed lower front side surface 44 of the tooth tips 41 help to prevent the skin from getting into the cutting zone at the tooth tips 41 of the movable teeth 8, even when the skin is bulging and wrapping, to some extent, around the tooth tips 41 as the skin may not follow the overhanging contour and thus, is prevented from reaching the contact point where the tooth tips 41 of the upper movable teeth 8 contact the lower teeth 9. The lower front side surface is substantially plane.

Said obtuse tooth tip angle α may range from 100° to 140° or from 110° to 130° or more particularly, from 115° to 125° to combine reliable skin protection with still high efficiency in cutting hairs short.

A shown by FIGS. 7, 12 and 13 the aforementioned forward end point 45 of the tooth tips 41 of the cutting teeth 8 of the upper movable cutter blade 4 is elevated to some extent from the cutting surface 40 and thus, from an upper surface 48 of the lower cutter blade 9, cf. FIGS. 7 and 8, by a distance 51 which may correspond to about 10% to 90% or 20% to 80% or 25% to 75% of a thickness 52 of said cutting teeth 8 which may be measured between lower and upper tooth sides 42, 43, cf. FIG. 7, in a region where the lower tooth side 42 contacts the cutting teeth 9 of the lower cutter blade 5, cf. FIG. 7.

As shown by FIG. 7, an upper front side portion 50 of the tooth tips 41 extending from said forward end points 45 to an upper tooth side 43 of the cutting teeth 8 of the upper movable cutter blade 4 may be rounded to further prevent skin irritations, wherein said upper front side portion 50 may define, together with the aforementioned lower front side portion 44, at said forward end points 45, an obtuse angle ε ranging from 110° to 140° or from 125° to 135°, cf. FIG. 13.

When considering the rounded contour of the upper front side portion 50, cf. FIG. 7, such obtuse angle ε represents the inclination of a tangential plane onto the upper front side portion 50 at said forward end point 45.

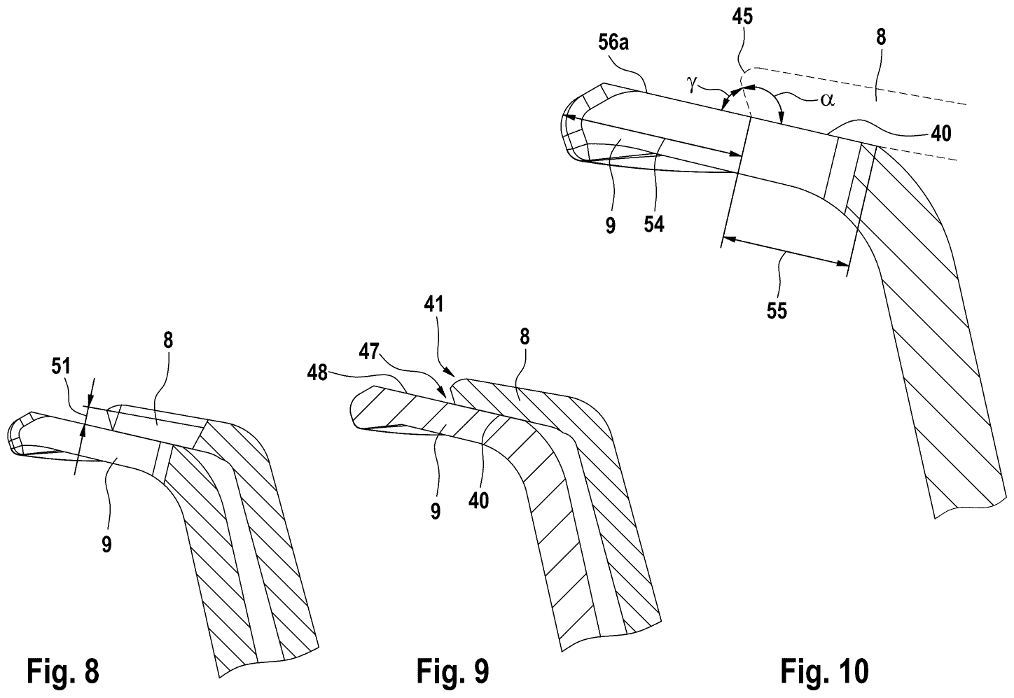

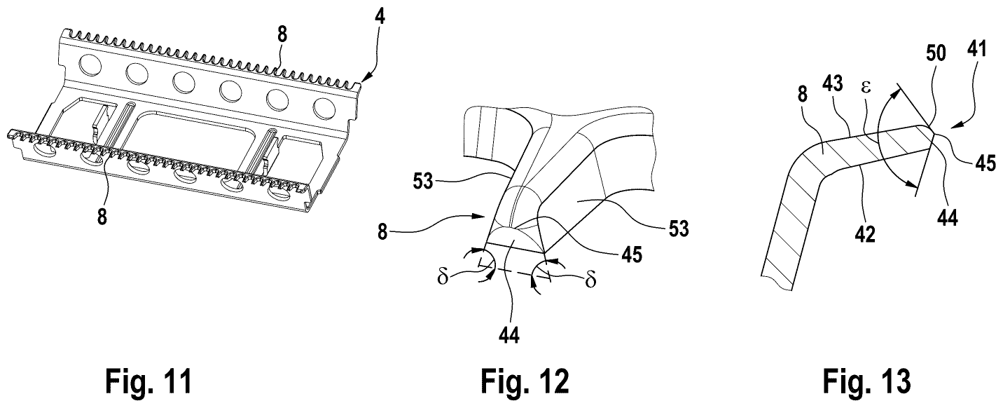

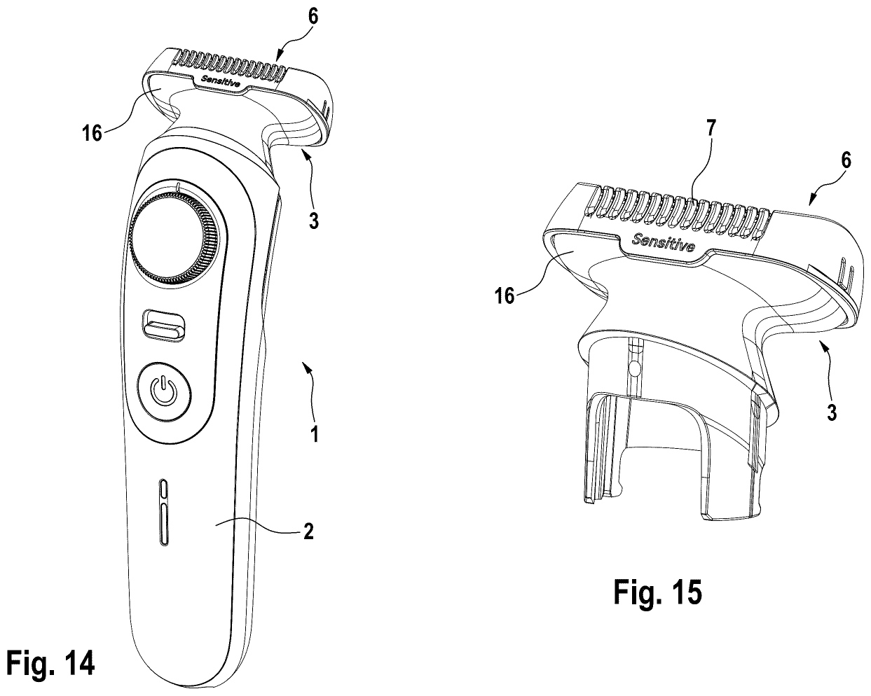

As shown by FIGS. 7 and 9, a step-like recess 47 is formed in front of the tooth tips 41 of the upper movable cutting teeth 8, said step-like recess 47 being defined between said tooth tips 41 and the upper side 48 of the lower cutting teeth 9 of the lower cutter blade 5, wherein such step-like recess 47 may define an acute angle γ, cf. FIG. 10, of less than 80° or less than 70°, cf. FIG. 10 showing the angle γ.

Such acute angle γ may be measured between an upper tooth side 48 of a projecting portion 49 of the cutting teeth 9 of the lower cutter blade 5 projecting beyond the cutting teeth 8 of the upper cutter blade 4, and the aforementioned lower front side portion 44 of the tooth tips 41 of the cutting teeth 8 of the upper cutter blade 4. FIG. 5 shows the projecting portion 49 of the lower teeth 9.

More particularly, said acute angle γ at the recess 47 in front of the tooth tips 41 of the upper cutting teeth 8 and the upper tooth sides 48 of the projecting portions 49 of the lower teeth 9 may range from 50° to 70° or from 55° to 65°. Due to such acute angle γ at said recess 47, the cutting zone at the tooth tips 41 of the movable cutting teeth 8 is sufficiently recessed from the forward end points 45 of said cutting teeth 8 to achieve reliable skin protection, whereas on the other hand cutting efficiency is still high.

As shown by FIG. 12, each of the cutting teeth 8 of the upper movable cutter blade 4 may have a pair of side surfaces 53 opposite to each other and extending transverse to the cutting direction 35, wherein said side surfaces 53 are inclined to the lower tooth side 42 facing the cutting surface 40 at an acute angle δ of less than 85° or less than 80° or ranging from 70° to 80°. Such inclination of the side surfaces make the teeth 8 sufficiently sharp on the one hand and sufficiently steep on the other hand to prevent the skin from reaching the cutting zone.

As shown by FIG. 5, the cutting teeth 9 of the lower cutter blade 5 may project, in longitudinal tooth direction 46b, beyond the tooth tips 41 of the cutting teeth 8 of the upper cutter blade 4 by a projecting distance 54 which may range from 50% to 150% or from 75% to 130% of an overlapping length 55, cf. FIG. 9, along which, in said longitudinal tooth direction 46b, the cutting teeth 8 of the upper cutter blade 4 are contacting the cutting teeth 9 of the lower cutter blade 5.

FIG. 5 further illustrates that said cutting teeth 9 of the lower cutter blade 5 may have at their tooth tip portions 56, a tooth width 57 in the cutting direction 35 that ranges from 0.5 mm to 1 mm or from 0.5 mm to 0.75 mm or from 0.60 mm to 0.70 mm. Such tooth width 57 may be measured at points 56a defining a transition between the substantially straight cutting edges of the teeth 9 and a rounding of the tooth tip portions 56, cf. FIG. 5.

the slot width 64 of which may range from 120% to 150% or from 125% to 135% of said tooth width 60 of the cutting teeth 8 of the upper cutter blade 4.

FIG. 5 also illustrates that the cutting teeth Said cutting teeth 9 of the lower cutter blades 5 define cutter slots 58 between each other having a slot width 59 which, when measured in the region of the tooth tips 41 of the cutting teeth 8 of the upper cutter blade 4, may range from 0.20 to 0.40 mm or from 0.25 to 0.36 mm or from 0.30 to 0.36 mm, cf. FIG. 5.

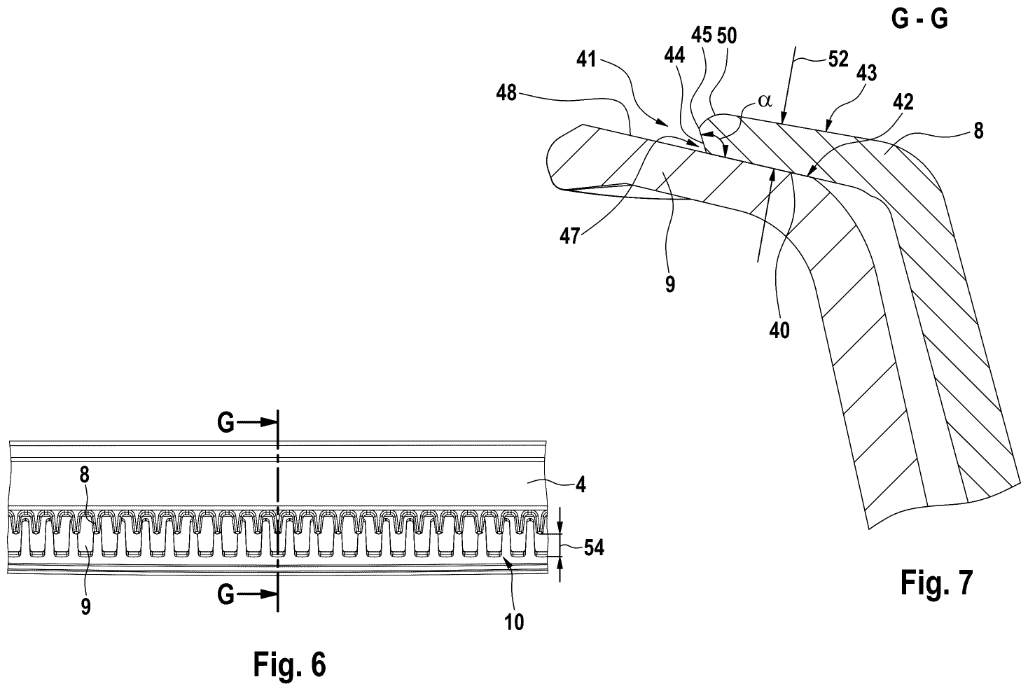

On the which the cutting teeth 8, 9 of the upper and lower cutter blades 4, 5 contact each other, may range from 33% to 66% or from 40% to 60% of the tooth width 57 of the cutting teeth 9 of the lower cutter blade 5. Such tooth width 60 may be measured halfway of the overlapping length 55 of the teeth 8, 9, cf. FIG. 10, and is shown in FIG. 5, and also illustrated by FIG. 6 on a larger scale.

FIG. 5 further illustrates that the cutting teeth 8 of the upper cutter blade 4 define cutter slots 61 between each other, 8 of the upper cutter blade 4 are spaced from each other by a tooth pitch 62 which is different other hand, the cutting teeth 8 of the upper cutter blade 4 have a tooth width 60 in the cutting direction 35, cf. FIG. 5, which tooth width 60, when measured in the cutting surface 40 in from and in particular, smaller than or ranges from 75% to 95% or 80% to 90% of a tooth pitch 63 at which the cutting teeth 9 of the lower cutter blade 5 are spaced from each other.

As shown by FIG. 17, the cutter head also may be used in combination with a protective comb. More particularly, a protective attachment 6 attachable to the cutter head frame 16 of cutter head 3 may include a ring-shaped attachment frame 34 the shape of which is basically adapted to the outline of the cutter head 3. As the shear foil system 11 and the rows 10 of cutting teeth 8, 9 may have an elongated shape and may define a substantially rectangular cutter system 19, said attachment frame 34 may have a substantially rectangular, elongated configuration, cf. FIG. 17.

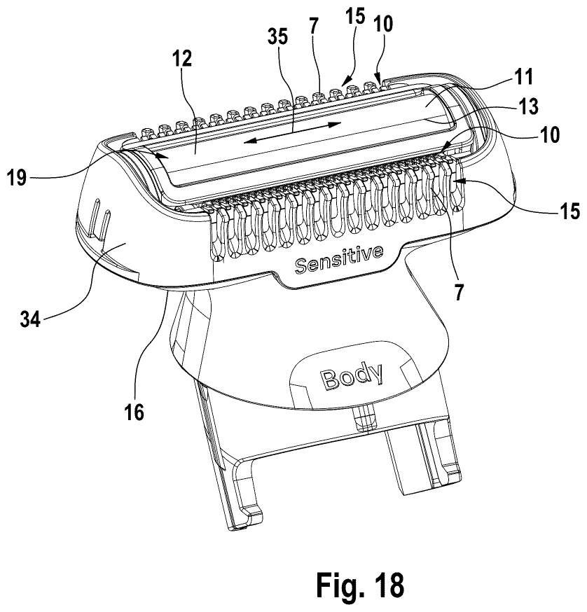

A pair of frame legs 38, which may form the longer sides of the attachment frame 34, may be provided with a row 15 of protective teeth 7 which may be aligned with each other and may have a shape or configuration identical to each other. When the protective attachment 6 is mounted onto the cutter head 3, said protective teeth 7 may be arranged along a front side of each of said row 10 of cutting teeth 8, 9, cf. FIGS. 18, 20, 21, 22 and 25, when considering said stroking directions 36 and 37.

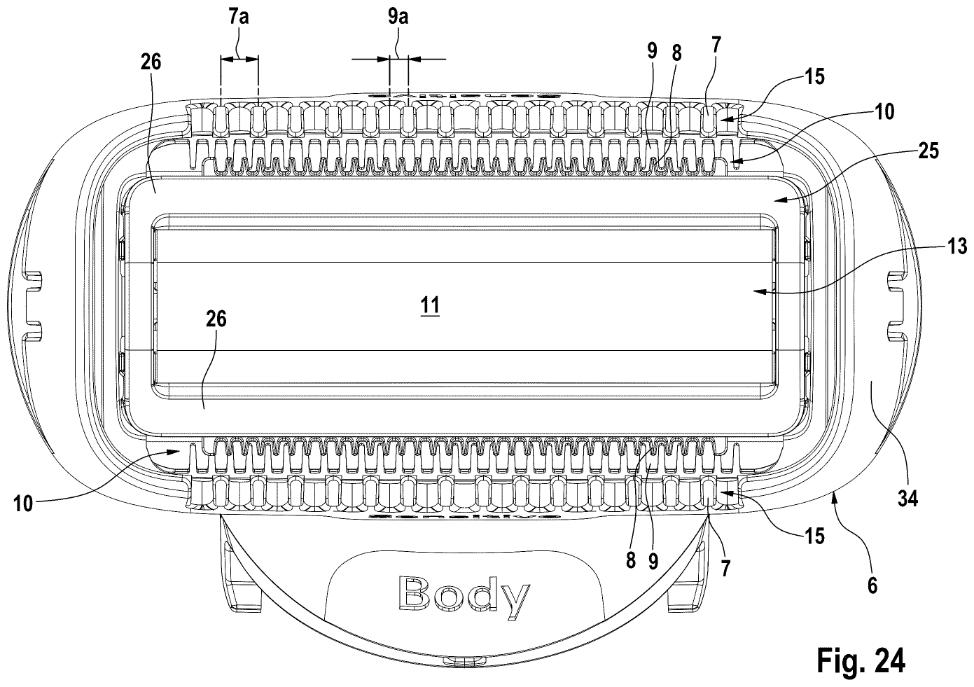

When considering a plane view substantially perpendicular onto the skin contact surface 14 of the cutter head 3, as it is shown by FIG. 24, the protective attachment 6 is adapted to the cutter head 3 such that a central cutter head region 25 including the shear foil system 11 and the two rows 10 of comb-like cutting teeth 8, 9 is left open and unobstructed by the protective attachment 6 so the skin has free access to the shear foil cutter system 11 from the top. The attachment frame 34 including the two rows 15 of protective teeth 7 extend only outside said central cutter head region 25 when considering the top view in a viewing direction substantially perpendicular onto the skin contact surface 14.

As mentioned, said rows 15 of protective teeth 7 are arranged on the front sides of the rows 10 of comb-like cutting teeth 8, 9, when considering the opposite stroking directions 36 and 37. So as to not block hairs from entering into the cutting zones of the cutter blades 4, 5 despite the protective teeth 7 being arranged on the front sides of the cutting teeth 8, 9, there are less protective teeth 7 than comb-like cutting teeth 8, 9. For example, the number of cutting teeth 8, 9 of cutter blades 4, 5 may be twice the number of protective teeth 7. Thus, the gaps between neighboring protective teeth 7 may be considerably larger than the gaps between neighboring teeth 8 or 9.

As can be seen from FIG. 24, the toothing pitch 7a of the protective teeth 7 may be an integer multiple of the toothing pitch 9a of the teeth 9 of the stationary cutter blade 5. For example, the toothing pitch 7a of the protective teeth 7 may be 200% of the toothing pitch 9a of the stationary cutting teeth 9.

Irrespective of the exact toothing pitch, the protective teeth 7 may be positioned exactly in front of one of the stationary cutting teeth 9, as it is shown by FIG. 24. Such a line positioning of the protective teeth 7 on the one hand and the stationary cutting teeth 9 on the other hand maximizes the width of the inner channels for the hairs entering into the cutting zone and, thus, makes the hairs reliably enter the cutting zone of the cooperating cutter blades 4, 5.

As can be seen from FIG. 22, the protective teeth 7, with their upper end side, and the sheer foil system 11 together define a tangential plane 18 which is a virtual one and does not exactly correspond to the skin contact surface 14 of the cutter head 3 since, in a region between the protective teeth 7 and the shear foil system 11, the skin contact surface 14 shows a depression 22. In other words, the elements arranged between said upper end portions of the protective teeth 7 on the one hand and the shear foil system 11 on the hand are in a countersunk position or lowered relative to the virtual tangential plane 18, cf. FIG. 22. Again, such virtual tangential plane may be, but does not have to be exactly tangential in a strictly mathematical sense, but may contact or lie onto the row of protective teeth and be spaced a minor distance from the shear foil to almost touch said shear foil, or may be slightly inclined by a minor angle vis-à-vis a plane that is tangential in the strict mathematical sense, as mentioned before.

In particular, the comb-like cutting teeth 8, 9 of the cooperating cutter blades 4, 5 are in such countersunk position below the virtual tangential plane 18 so the skin, even then bulging towards the cutter head 3, does not directly contact the comb-like cutting teeth 8, 9, cf. FIG. 22 showing by a curved hatched line such skin bulging.

As illustrated by FIG. 22, the offset 23 of the cutting teeth 8, 9 from said tangential plane 18 may be about 0.5 mm for example. More generally, such countersunk offset 23 may be substantially corresponding to or slightly smaller than the diameter 24 of the perforation 17 of the shear foil cutter system 11.

As illustrated by FIGS. 16, 18 and also 21 and 22, the skin contact brackets 26 may be formed on a rear side of the rows 10 of comb-like cutting teeth 8, 9 or, more generally, between said comb-like cutting teeth 8, 9 and the shear foil system 11. Such skin contact brackets 26 may have an elongated contour and/or may form ribs extending substantially parallel to said rows 10 of cutting teeth 8, 9. Such skin contact brackets 26 may form further parts of the skin contact surface 14, wherein such skin contact brackets 26 nevertheless may fulfil a double function since they may be used to hold or mount the shear foil of the shear foil cutter 12, cf. FIG. 22.

When considering the stroking directions 36 and 37, cf. FIGS. 20 and 22, there may be concavities 28 and 27 on opposite sides of said skin contact bracket 26 wherein such concavities 27, 28 may form part of the aforementioned depression 22 of the skin contact surface 14. Thus, the upper surface of the skin contact bracket 26 forms part of the skin contact surface 14.

As can be seen from FIG. 22, such upper surface of the skin contact bracket 26 may be tangential to or may form part of a second tangential plane 29 which is defined by contacts. The shear foil system 11 on the one hand and the tooth tips of the cutting teeth 8, 9 on the other hand, cf. FIG. 22. Thus, this offset 23 between both parallel lines 29 and 18 creates a stubble trimming which is easily later shaved by the short hair cutting shear foils system as shorter hairs are more easily caught by a shear foil cutting system than longer hairs. The dotted line 91, shows an exemplary skin bulging with the protective attachment being attached to the cutter head. Thus, the skin follows the inclined skin contact surface of the top side of the teeth of the protective attachment, is then pushed into the depression towards the top side of the cutting teeth 8, 9 and then follows along line 29 or 90 towards the shear foil cutting system.

So as to make the cutter head 3 smoothly slide along the skin surface, the protective teeth 7 may have a rounded front edge 31 which is the protective teeth's edge facing away from the comb-like cutting teeth 8, 9.

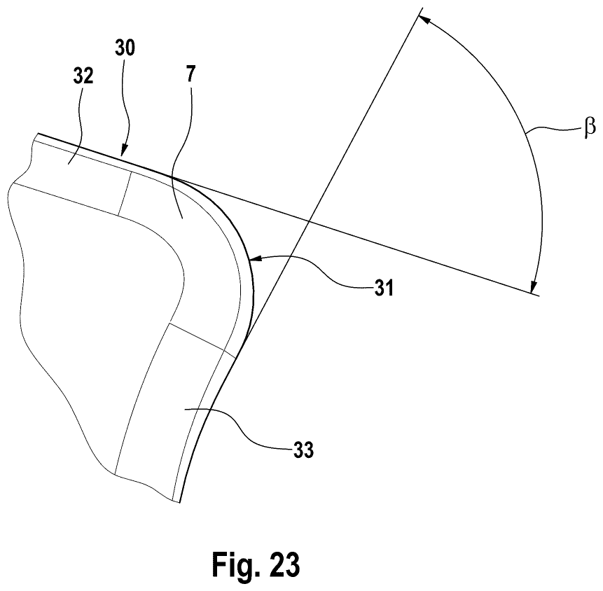

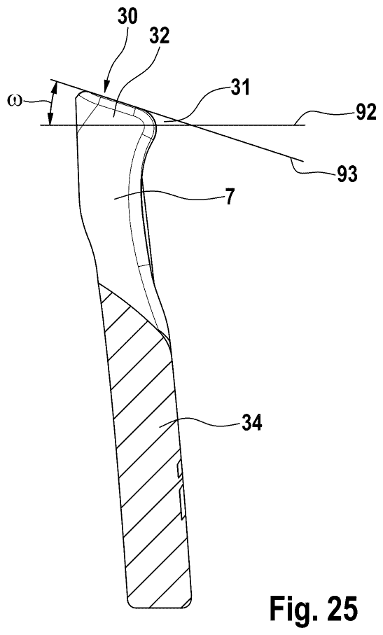

As illustrated by FIG. 23, said rounded front edge 31 connects the tooth flanks 32 and 33 to each other, wherein an upper one 32 of said tooth flanks 32, 33 forms the aforementioned top end surface 30 defining part of the skin contact surface 14. As shown with FIG. 25, each protective tooth of the protective attachment has a top end surface 30 which is inclined along line 93 relative to a horizontal line 92 by angle \acute{ω}, said angle ranging from 10° to 35°. This optional inclination cases, forming the depression as the skin is guided upwards along its way to the shear foil. See also FIG. 22 and line 90 therein which connects the top end surface with a tangential to the shear foil and which basically coincides with line 93.

As illustrated by FIG. 23, said tooth flanks 32, 33 connected to each other by the rounded front edge 31 may be inclined relative to each other at an acute angle β, wherein such acute angle β may be about 80° or may range from about 75-85°.

As described above the intimate trimmer or body groomer comprises a handle 2, which allows to exchange and attach different types of cutter heads 3 suitable for different trimming or shaving purposes. Said body groomer or intimate trimmer cutter head 3 comprise a cutting unit which may be exchanged and replaced by another one if the blades become blunt or worn out within the cutter head housing. This replaceable cutting unit comprises cooperating long hair trimmer cutter blades 4,5 at the opposite longer sides and a short hair cutting shear foil system 11 in-between. Other types of cutters and blade arrangements, e.g. without a short hair cutter and/or only one long hair cutter and/or a different sequence of its arrangement relative to each other and/or other functional units are alternatively used. Alternatively, the cutter head 3 with the cutter head frame 16 is not replaceably provided in favor of a more compact overall design and integral with the handle. Further alternative, the handle is not elongate, but wider than longer.

Thus, by the above described intimate trimmer, the long hair cutter blades first trim the hair to a stubble length of less than 1 mm and second the short hair cutting shear foil system can easily catch the stubble hairs, then cut or shave the hairs, so that no remaining stubbles are left over. For this purpose, the user simply has to glide the trimmer or body groomer over the skin in a slightly inclined way—along line 90, with the protective comb attachment 6 attached or along line 29 without protective attachment—by following the inclination of the skin contact surfaces and the roof like shape of one side of the cutter head 3.

In order to further protect sensitive very thin skin as provided in the human intimate area from being cut by the long hair trimmer blades 3,4 the user has to attach the protective comb attachment 6 which surrounds the cutter head cutting blades. The teeth of the protective comb attachment not only pre comb the hair, which improves the trimming efficiency but also avoids frontal contact with the trimming teeth, as otherwise thin skin could fold and bulge between such cutting teeth 8, 9 and would be cut. Non thin skin would not bulge between the teeth during usual operation. Further the teeth of the protective comb attachment elevate the skin contact level relative to the cutting teeth 8, 9 which are then located in a depression. Thus, the thin skin as provided in intimate areas-which is more easily prone to bulge-will still bulge close to the cutting teeth 8, 9, without being cut.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. Cutter head for an intimate trimmer or body groomer, comprising a pair of cooperating cutter blades each having at least one row of comb-like cutting teeth for long hair cutting, said cutter blades including a lower cutter blade and an upper cutter blade which is closer to a skin contact surface than said lower cutter blade and which upper cutter blade is movable in a cutting direction along a cutting surface defined between said cooperating cutter blades, wherein the cutting teeth of the upper, movable cutter blade have tooth tips with obtuse tooth tip angles (α) ranging from about 100° to about 150° or from about 110° to about 140° defined between a lower tooth side facing said cutting surface and a lower front side portion extending from said lower tooth side to a forward end point defining a maximum longitudinal tooth extension.

2. Cutter head according to claim 1, wherein the cutting teeth of the lower cutter blade extend beyond the tooth tips of the cutting teeth of the upper cutter blade in a longitudinal tooth direction which is transverse to the cutting direction, wherein a step-like recess with an acute angle (γ) of less than about 80° or less than about 70° is defined between an upper tooth side of a projecting portion of the cutting teeth of the lower cutter blade projecting beyond the cutting teeth of the upper cutter blade and said lower front side portion of the tooth tips of the cutting teeth of the upper cutter blade.

3. Cutter head according to claim 2, wherein said acute angle (γ) ranges from about 50° to about 70° or from about 55° to about 65°.

4. Cutter head according to claim 1, wherein the tooth tips of the cutting teeth of the upper, movable cutter blade include a rounded upper front-side portion extending from said forward end point to an upper tooth side facing away from the lower cutter blade, wherein said upper and lower front side portions of the tooth tips of the cutting teeth of the upper movable cutter blade define, at said forward end point, an obtuse angle (ε) of more than about 100° or more than about 110° or ranging from about 110° to about 140° or from about 125° to about 135°.

5. Cutter head according to claim 1, wherein said forward end point is spaced from the cutting surface by a distance corresponding to about 10% to about 90% or about 20% to about 80% or about 25% to about 75% of a thickness of the cutting teeth of the upper, movable cutter blade measured between lower and upper tooth sides in a region where said lower tooth side contacts the cutting teeth of the lower cutter blade.

6. Cutter head according to claim 1, wherein said lower front side portion of the tooth tips of the cutting teeth of the upper, movable cutter blade is plane.

7. Cutter head according to claim 1, wherein each of said cutting teeth of the upper movable cutter blade has a pair of side surfaces opposite to each other and extending transverse to the cutting direction, wherein said side surfaces are inclined to the lower tooth side facing the cutting surface at an acute angle (δ) of less than about 85° or less than about 80° or ranging from about 70° to about 80°.

8. Cutter head according to claim 1, wherein the cutting teeth of the lower cutter blade project, in longitudinal tooth direction, beyond the tooth tips of the cutting teeth of the upper cutter blade by a projecting distance which ranges from about 50% to about 150% or from about 75% to about 130% of an overlapping length along which, in said longitudinal tooth direction, the cutting teeth of the upper cutter blade are contacting the cutting teeth of the lower cutter blade.

9. Cutter head according to claim 1, wherein said cutting teeth of the lower cutter blade have, at their tooth tip portions at end points of straight cutting edges, a tooth width in the cutting direction that ranges from about 0.5 mm to about 1 mm or from about 0.5 mm to about 0.75 mm or from about 0.60 mm to about 0.70 mm, wherein said cutting teeth of the lower cutter blades define cutter slots between each other having a slot width which, when measured at the tooth tips of the cutting teeth of the upper cutter blade, ranges from about 0.20 to about 0.40 mm or from about 0.25 to about 0.36 mm or from about 0.30 to about 0.36 mm.

10. Cutter head according to claim 1, wherein the cutting teeth of the upper cutter blade have a tooth width in the cutting direction which tooth width, when measured halfway of the overlapping length of the cutting teeth of the upper and lower cutter blades in the cutting surface in which the cutting teeth of the upper and lower cutter blades contact each other, ranges from about 33% to about 66% or from about 40% to about 60% of the tooth width of the cutting teeth of the lower cutter blade, wherein the cutting teeth of the upper cutter blade define cutter slots between each other ranging from about 120% to about 150% or from about 125% to about 135% of said tooth width of the cutting teeth of the upper cutter blade.

11. Cutter head according to claim 1, wherein the cutting teeth of the upper cutter blade are spaced from each other by a tooth pitch which is smaller than or ranges from about 75% to about 95% or about 80% to about 90% of a tooth pitch at which the cutting teeth of the lower cutter blade are spaced from each other.

12. Cutter head according to claim 1, wherein the cutting teeth of the upper cutter blade define, with their upper tooth sides, part of the skin contact surface of the cutter head.

13. Cutter head according to claim 1, wherein a removably attachable protective attachment includes a row of comb-like protective teeth arranged on a front side of said cutting teeth of the cutter blades.

14. Cutter head according to claim 13, wherein said row of protective teeth and said trailing portion such as a shear foil system together form parts of a skin contact surface of the cutter head, wherein said skin contact surface provides for a depression for skin bulging between said row of protective teeth and said shear foil system, wherein said row of cutting teeth for long hair cutting is arranged in said depression, wherein said cutting teeth are arranged in a countersunk position below a virtual tangential plane to said comb-like protective teeth of said protective attachment and a trailing portion of the cutter head on a rear side of said cutting teeth or said cutting teeth are offset from said virtual tangential plane by a distance ranging from about 25% to about 125% or about 33% to about 100% or about 50% to about 95% of a diameter of perforations of said shear foil system, or by a distance which is within the range from about 0.1 to about 0.6 mm or from about 0.2 to about 0.5 mm or from about 0.3 to about 0.5 mm.

15. Cutter head according to claim 14, wherein said protective attachment is formed exclusively outside a central cutter head region in which at least said at least one row of cutting teeth and an optional shear foil system are arranged so, when considering a viewing direction perpendicular onto said skin contact surface, the cutting teeth of the upper movable cutter blade and the optional shear foil system are left unobstructed by said protective attachment.

16. Cutter head according to claim 1, wherein a skin contact bracket is provided between a/said shear foil system and said row of cutting teeth of the upper cutter blade, wherein a deepening is provided between said skin contact bracket and said shear foil system or a deepening is provided between said skin contact bracket and said row of cutting teeth, wherein said skin contact bracket forms a part of the skin contact surface of the cutter head which part of the skin contact surface formed by the skin contact bracket is tangential to or adjacent to a virtual tangential plane onto said shear foil system and said row of cutting teeth of the upper, movable cutter blade.

17. Hair cutter according to claim 1, for cutting hair in sensitive or intimate body regions, comprising an elongated handle and a cutter head attachable to said handle.

18. Hair cutter according to claim 17, comprising a drive unit for driving the upper cutter blade in a reciprocating manner at a frequency of more than about 75 Hz or more than about 90 Hz.
